(19) United States
(12) Patent Application Publication
(10) Pub. No.: US 2014/0174903 A1
(43) Pub. Date: Jun. 26, 2014

(54) Stripping Gas Recycle System

(71) Applicant: Process Group Technologies Pty. Ltd., Rowville (AU)

(72) Inventors: Damien EDWARDS, Rowville (AU); Adam GEARD, Rowville (AU); Michael CAVILL, Rowville (AU); Trina Margaret DREHER, Rowville (AU)

(73) Assignee: Process Group Technologies Pty. Ltd., Rowville (AU)

(21) Appl. No.: 14/100,601

(22) Filed: Dec. 9, 2013

(30) Foreign Application Priority Data
Dec. 20, 2012 (AU) 2012 268912

(51) Int. Cl. B01D 5/00; B01D 53/26

(52) U.S. Cl. CPC B01D 5/006; B01D 53/26; B01D 53/265
USPC 203/18; 95/267; 95/288

(57) ABSTRACT

A stripping gas recycle process for a stripper is fed a water containing glycol and a stripping gas. The stripping gas removes a water content from the water containing glycol to produce a dried glycol and a wet stripping gas. The recycle system includes at least one stripping gas separation process, with the gas separation process being fed wet stripping gas from a stripper and separating the water content from the wet stripping gas, to produce a water containing fraction and a drier stripping gas fraction. The drier stripping gas fraction is fed into the stripper.

### CROSS REFERENCE TO RELATED APPLICATIONS

This application claims priority in Australian Patent application no. 2012 268912 filed 20 Dec. 2012, the contents of which are hereby incorporated by reference.

### TECHNICAL FIELD

The present invention generally relates to a process and system for recycling stripping gas for a stripping unit and glycol based regeneration processes which includes that recycle process. The invention is particularly applicable for processes for dehydrating natural gas produced at an oil or gas field, for example a coal seam gas field, and it will be convenient to hereinafter disclose the invention in relation to that exemplary application. However, it is to be appreciated that the invention is not limited to that application and could be used in a variety of other glycol regeneration processes and applications.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Gas production at oil and gas fields contains a water content, typically in the form of water vapour, that it is desirable to remove. A number of gas dehydration processes have been developed to remove this water content. A number of these processes use glycol to dehydrate the gas streams. There are three common types of glycol used for gas dehydration: Mono-Ethylene Glycol (MEG); Di-Ethylene Glycol (DEG); and Tri-Ethylene Glycol (TEG). The use of glycol for dehydrating gas is an established method, and is described in a number of prior patents, for example U.S. Pat. No. 4,332,643 (the Coldfinger process) and, U.S. Pat. No. 6,004,380 (the Drizo process).

The basic process steps for such gas processes are generally similar. In each process, a water containing gas, such as methane, is fed into a contactor column in a countercurrent flow direction to a glycol drying agent such as triethylene glycol (TEG). The TEG is typically in the range of 95 to 99.99 wt % (balance water). The contactor is a packed column operating at low temperature and high pressure. Lean glycol is introduced at the top of the column and cascades down through the internal trays/packing while gas is fed in at the bottom of the column. Dehydrated gas flows out of the top of the contactor, while the wet or water rich glycol flows out of the bottom of the contactor and to a glycol regeneration process.

Conventional regeneration processes include a regenerator unit, typically comprising a still column and reboiler. The wet glycol is fed at the top of the still column, with a content of the water being vaporised to produce a top fraction containing water and any gas that is present and a bottom fraction comprising a drier glycol. The reboiler typically operates at around atmospheric pressure and around 204° C. and at these conditions produces a maximum TEG purity of ˜98.9 wt %.

In order to obtain a higher purity TEG, a further dehydration process is used. Most commonly, a method based on the principle of reducing the effective partial pressure of H₂O in a vapour space is used, allowing a higher glycol concentration to be produced at the same temperature. Conventional methods include the use of a stripping gas, vacuum regeneration, the DRIZO process (see U.S. Pat. No. 6,004,380), or the Coldfinger process (see U.S. Pat. No. 4,332,643).

Most commonly, the drier glycol fraction from the regenerator is fed through a stripping column to further dehydrate the glycol. The stripping column typically uses a countercurrent stripping gas to contact and strip further water content from the glycol. The regenerated TEG from this traditional dehydration is about 98.9 to 99.98 wt % pure. Further dehydration processes, such as the Coldfinger process (see U.S. Pat. No. 4,332,643) may also be used to remove further water content from the glycol.

The stripping gas used in existing systems comprises either an expensive purified externally supplied gas such as nitrogen, carbon dioxide, a flue gas from the reboiler or other source, or a methane containing gas, such as a fuel gas or flash gas sourced from a process stream within the regeneration system. Once used, the stripping gas is disposed of, usually by direct venting to atmosphere or to flare. Environment regulations are increasingly penalising carbon containing emissions. For example, in Australia, the introduction of a carbon tax on such carbon emissions provides an economic basis for reducing the amount of carbon containing emissions. It is therefore desirable to avoid the use of an additional stripping gas, and reduce the emission of carbon containing gas.

One process which uses a recycled stripping gas in the stripping column is described in U.S. Pat. No. 6,299,67. This patent describes a method for regeneration of TEG that has been used as a drying medium to remove water from a fluid such as natural gas. In the process, a regenerator and a stripping column are situated on either side of a heating device. TEG is fed into the regenerator for water removal. TEG is recovered at the bottom fraction in a regenerator and water vapour together with other gases is removed at the top fraction of the regenerator. Partially dried TEG from the regenerator can also be supplied to the stripping column for further dehydration. In the stripping column, a stripping gas comprising a portion of the used gas recovered from the top fraction from the regenerator is fed into the stripping column countercurrent to the TEG stream in order to improve removal of water from the TEG. An excess portion of that used gas is still flared or otherwise disposed of.

While a useful amount of gas may be recycled, the process of U.S. Pat. No. 6,299,67 requires the entire gas flow of the regenerator to be processed in order to recover the stripping gas (in this case methane) for use in the stripping column. The gas volume processed can therefore require large process equipment, which will increase plant cost and can take up valuable space. Minimising equipment space can be important in environments such as oil rigs, other offshore processing platforms and a number of mining sites. Furthermore, a portion of the stripping gas from the process still needs to be disposed of, producing carbon emissions for the process.

It would therefore be desirable to provide an improved and/or alternative gas dehydration process and system which recycles at least some of, preferably the majority of, the stripping gas used in the stripping column.

### SUMMARY OF THE INVENTION

The present invention provides in a first aspect a stripping gas recycle system for a stripper which removes a water content from a water containing glycol dehydration agent using a stripping gas to produce a dried glycol and a wet stripping gas, the recycle system comprising:

at least one stripping gas separation process, the stripping gas separation process being fed wet stripping gas from a stripper and separating the water content from the wet stripping gas, to produce a water containing fraction and a drier stripping gas fraction, the drier stripping gas fraction being fed into the stripper.

The stripping gas from the stripping gas recycling system is contained in a substantially closed gas recycle system that circulates through a stripper. The recycle process therefore has minimal gas emissions once a working amount of stripping gas is fed, accumulated or otherwise entered into the stripping system for recycle. In some embodiments, some stripping gas may escape the systems due to pressure and other process requirements. In these embodiments, make up stripping gas may also need to be fed into the system when required.

It should be appreciated that the term “dried” is intended to indicate that a liquid, in most cases water, content has been removed from that dried component, and therefore that component has a lower water content after the preceding drying, dehydration or liquid separation method. It is not intended that the term dried indicates that that component has all of the liquid content removed. It should be appreciated that some liquid content may still remain in the dried product due to the operating conditions and in some cases process limitations of the preceding drying, dehydration or liquid separation method. Similarly, the term “partially dried” is intended to indicate that a portion of the liquid (typically water) content of that component has been removed. Further drying, dehydration or liquid separation methods can subsequently be used to remove further liquid content from the partially dried component.

The stripping gas separation process can comprise any suitable gas-liquid separation process. In some embodiments, the stripping gas separation process comprises at least one of: a cooling process, in which the water content is condensed and separated from the stripping gas; a gas-liquid separator, preferably a knock-out drum, in which the condensed water content is separated from the stripping gas; or a stripping process, in which the wet stripping gas is contacted with a secondary stripping fluid to separate the water content from the stripping gas.

It should be appreciated that any glycol content entrained or otherwise contained in the wet stripping gas is preferably also substantially separated from the stripping gas during the stripping gas separation process.

Where a cooling process is used, any suitable heat exchanger can be used to transfer energy from the wet stripping gas stream to a suitable cooling fluid process stream. Suitable heat exchangers include (but are not limited to) shell and tube heat exchangers, plate heat exchangers, plate and shell heat exchangers, adiabatic wheel heat exchangers, plate fin heat exchangers, pillow plate heat exchangers, dynamic scraped surface heat exchangers, direct contact heat exchangers, spiral heat exchangers or air-cooled heat exchangers.

The wet stripping gas is at a temperature of at least 120° C., more typically at least 150° C., more typically around 200° C. when entering the stripping gas separation process. The cooling process preferably cools the wet stripping gas to 0 to 99° C., preferably 20 to 80° C., more preferably 40 to 60° C., yet more preferably about 50° C. for condensation of the water content contained in the wet stripping gas.

In some embodiments, a knock-out drum can be used, or as an addition to a prior process, to separate the water content from the stripping gas. Any suitable gas-liquid separator can be used, such as a knock-out drum, blowdown tank or flash type tank or vessel.

In some embodiments, the stripping gas separation process includes at least one cooling process, preferably at least one heat exchanger, to cool the gas to 0 to 99° C., preferably 20 to 80° C., more preferably 40 to 60° C., yet more preferably about 50° C., followed by a further separator, preferably a knock-out drum or flash type separator.

The water containing fraction separated from the stripping gas separation process is preferably fed into a further separation process to recover any glycol content contained in the water content of that fraction. In some embodiments, the further separation process comprises a flash process, such as a flash tank. Where possible, the flash process used preferably forms part of a process for regeneration of water containing glycol that has been used as a drying medium to remove water from a fluid. The glycol can therefore be recycled back into that regeneration process.

The stripping gas recycle system can include a number of additional process steps and equipment in the process loop between the wet stripping gas inlet and the dry stripping gas outlet. In some embodiments, the stripping further includes a pressure enhancing device, preferably a pump, blower, eductor or compressor, to increase the gas pressure of the drier stripping gas fraction prior to being fed into the stripper. Some embodiments further include a heating process in which the drier stripping gas is heated prior to being fed into the stripper. The stripping gas is preferably heated 50 to 200° C., preferably between 80 to 150° C., more preferably to about 150° C. In some embodiments, the heating process can use a heat source from a co-located vessel, for example a heater section of a regenerator or the like.

The stripping gas recycle system of the present invention is a substantially closed gas recycling system, where an amount of stripping gas is recycled through a fluidly connected stripper to dehydrate a water containing glycol flowing therethrough. However, it should be appreciated that the recycle system must be initially charged with a desired amount of stripping gas, and that in certain circumstances and embodiments, a make-up amount of stripping gas may be needed to be added to the stripping gas recycle system in order to make up for any lost stripping gas from the stripping gas recycle system/loop. The stripping gas recycle system can therefore further include a gas inlet through which at least one of the following can be fed into the gas recycle system: a stripping gas content during start up; or a make-up content of the stripping gas. The gas inlet can be located at any location in the loop. In preferred embodiments, the gas inlet is located between the stripping gas separation process and a fluid connection to the fluidly connected stripper.

Any suitable stripping gas may be used. However, the stripping gas preferably comprises at least one of CO₂, N₂, or a low molecular weight hydrocarbon. Where the stripping gas comprises a low molecular weight hydrocarbon, that low molecular weight hydrocarbon preferably has the formula CₙHₙ₊₂, wherein n is an integer in the range of 1 to 4. The low molecular weight hydrocarbon preferably includes no more than 3 carbon atoms, more preferably no more than 2 carbon atoms. Most preferably, the low molecular weight hydrocarbon comprises methane or a gas mixture substantially comprising methane. In some embodiments, the stripping gas comprises a component removed from a process step of an adjoining gas regeneration process, preferably a process for regeneration of a water containing glycol that has been used as a dehydration agent to remove water from a fluid.

It should be appreciated that the stripping gas recycle process can be integrated as part of a stripper and/or glycol regeneration processes. Equally, the stripping recycle process could be retrofitted into an existing stripping and/or glycol regeneration processes.

A second aspect of the present invention provides a stripping process for regeneration of a water containing glycol dehydration agent, the stripping process comprising:

a stripper which is fed a water containing glycol and a stripping gas, the stripping gas removing a water content from the water containing glycol to produce a dried glycol and a wet stripping gas; and

a stripping gas recycle system according to the first aspect of the present invention.

The second aspect therefore provides the combination of a stripper in fluid communication with, preferably fitted with, a stripping gas recycle system of the present invention. The stripping gas process flow of the overall combination therefore operates as a closed circuit where the stripping gas entrains a water content from the wet glycol and is substantially dehydrated in the stripping gas recycle system to enable that gas to be recycled back for use in the stripper.

The stripper can comprise any suitable water stripping unit process. In a preferred embodiment, the stripper comprises a stripping column, preferably a packed column. The stripping gas preferably flows countercurrent to the glycol stream in the stripper. The stripping gas can be fed in any suitable location. In preferred embodiments, the stripping gas is fed at a location near the bottom of the stripping column, and the wet glycol is fed at a location near the top of the stripping column.

A third aspect of the present invention provides a process for regeneration of water containing glycol dehydration agent that has been used to remove water from a fluid, preferably a methane containing gas such as natural gas. The process includes:

a regenerator into which the water containing glycol is fed, the regenerator separating a water content from the water containing glycol to substantially produce water vapour as a top fraction and a partially dried glycol as a bottom fraction;

a stripper which is fed the partially dried glycol from the regenerator and a stripping gas, the stripping gas removing further water content from the glycol to produce a dried glycol and a wet stripping gas; and

a stripping gas recycle system according to the first aspect of the present invention.

The third aspect therefore provides a process for regeneration of water containing glycol dehydration agent including a regenerator, a stripper and the stripping gas recycle system according to the first aspect. It should be appreciated that a regenerator and a stripper can be fluidly connected in a number of different ways. In some embodiments, the regenerator and stripper comprise part of a common column. In some embodiments, the regenerator and stripper form independent process units fluidly connected via fluid connections, such as conduits or pipes. In some embodiments, the regenerator and stripper are integrated in single vessel connected by a fluid reservoir which interconnects the lower glycol fluid outlet of the regenerator and the upper glycol fluid outlet of the stripper. The fluid reservoir may include a heating device, for example a heating element, coil, duct or the like. The heating device preferably forms part of the reboiler of the regenerator, heating the glycol for a still column portion of the regenerator. In each of these embodiments, it is preferred that the gas/vapour content of the stripper is substantially fluidly separated from the gas/vapour content of the regenerator. This separation ensures that the stripping gas does substantially flow through the stripper and the stripping gas recycle process and not bypass through the regenerator.

In some embodiments, the process further comprises a heater fluidly linked between the stripper and the regenerator. Again, the heating device preferably forms part of the reboiler of the regenerator, heating the glycol for a still column portion of the regenerator. The heater heats the partially dried glycol, preferably to between 180 to 210° C., preferably between 190 to 205° C., more preferably to about 200° C. to 204° C.

In some embodiments, the heater and regenerator are formed as an integrated vessel, with the heater fluidly attached to the base of the regenerator, heating the partially dried glycol. The inlet of the stripper can be fluidly connected to the heater via a fluid connection, such as a conduit or pipe. In other embodiments, the heater, regenerator and stripper are formed as separate vessels/process units which are fluidly connected via a fluid connection, such as a conduit or a pipe.

In other embodiments, the stripper, heater and regenerator are integrated within a single fluidly connected vessel. Again, it is preferable that the gas/vapour content of the stripper is substantially fluidly separated from the gas/vapour content of the regenerator. Thus, in some embodiments, the stripper is located in a stripper portion of the fluidly connected vessel and the regenerator is located in regenerator portion of the fluidly connected vessel, the regenerator portion being spaced apart from the stripper portion, the fluidly connected vessel further including a fluid barrier between the regenerator portion and the stripper portion, substantially fluidly separating the gas/vapour content of the stripper portion from the gas/vapour content of the regenerator portion. The fluid barrier is preferably located in the heater between the regenerator portion and the stripper portion.

The fluid barrier can have any suitable configuration. In some embodiments, the fluid barrier comprises a plate, preferably a baffle or a weir. The fluid barrier may cause a pressure imbalance between the gas/vapour portions of the stripper portion and the regenerator portion. It is therefore preferable that the fluid barrier includes at least one fluid communication element between the gas/vapour content of the stripper portion and the gas/vapour content of the regenerator portion. In some embodiments, the fluid communication element comprises at least one aperture.

Any suitable glycol based water dehydrating agent can be used in each of the aspects of the invention. In preferred embodiments, the glycol based water dehydrating agent comprises at least one of Mono-Ethylene Glycol (MEG), Di-Ethylene Glycol (DEG), Tri-Ethylene Glycol (TEG), or Tetra-Ethylene Glycol, or mixtures thereof. In a preferred embodiment, the glycol based water dehydrating agent comprises Tri-Ethylene Glycol (TEG).

The stripper preferably comprises a stripping column. Similarly, the regenerator preferably comprises a regenerator column, more preferably a still column and a fluid connector reboiler. Each column preferably comprises a packed column.

A fourth aspect of the present invention provides a method for regeneration of water containing glycol based dehydration agent that has been used to remove water from a fluid, the process including:

a regeneration process in which a water content is separated from the water containing glycol to substantially produce water vapour and a partially dried glycol;

a stripping process in which a further water content is separated from the partially dried glycol using a stripping gas to produce a dried glycol and a wet stripping gas; and

a stripping gas recycle process in which the water content is substantially separated from the wet stripping gas, to produce a water vapour and a drier stripping gas, the drier stripping gas being recycled into the stripping step.

The method of the fourth aspect is preferably implemented in the process of the third aspect of the present invention.

A number of existing installed glycol regeneration processes would benefit from being retrofitted with a stripping gas recycle system according to the present invention. A fifth aspect of the present invention provides a method of retrofitting a stripper which removes a water content from a water containing glycol dehydration agent, the stripper including a first inlet for the water containing glycol and a second inlet for stripping gas, a first outlet for the dried water containing glycol and a second outlet for a wet stripping gas, the method comprising the steps of:

connecting a stripping gas recycle system according to the first aspect of the present invention between the second inlet and second outlet of the stripper.

In some embodiments, the stripper is integrated into a single vessel with a regenerator connected by a fluid reservoir which flows between a glycol fluid outlet of the regenerator and the first (glycol) outlet of the stripper. The regenerator is preferably fed a water containing glycol and separates a water content from the water containing glycol to substantially produce water vapour as a top fraction and a partially dried glycol as a bottom fraction, which flows out from the glycol fluid outlet of the regenerator. In these embodiments, the stripper is located in a stripper portion of the fluidly connected vessel and the regenerator is located in regenerator portion of the fluidly connected vessel, the regenerator portion being spaced apart from the stripper portion. The fluid reservoir may include a heating device, for example a heating element, coil, duct or the like. The heating device preferably forms part of the reboiler of the regenerator, heating the glycol for a still column portion of the regenerator. Again, it is preferred that the gas/vapour content of the stripper is substantially fluidly separated from the gas/vapour content of the regenerator. This separation ensures that the stripping gas to substantially flow through the stripper and the stripping gas recycle process and not bypass through the regenerator.

In such embodiments, the method preferably includes a further step of:

installing a fluid barrier between the regenerator portion and the stripper portion, the fluid barrier being positioned in the fluidly connected vessel to substantially fluidly separate the gas/vapour content of the stripper portion from the gas/vapour content of the regenerator portion.

Where the fluidly connected vessel includes a heater or heater portion, the fluid barrier is preferably located in the heater or heater portion, again at a location between the regenerator portion and the stripper portion.

As previously discussed, the fluid barrier can have any suitable configuration. In some embodiments, the fluid barrier comprises a plate, preferably a baffle or a weir. The fluid barrier may cause a pressure imbalance between the gas/vapour portions of the stripper portion and the regenerator portion. It is therefore preferable that the fluid barrier includes at least one fluid communication element between the gas/vapour content of the stripper portion and the gas/vapour content of the regenerator portion. In some embodiments, the fluid communication element comprises at least one aperture.

### BRIEF DESCRIPTION OF THE DRAWINGS

The present invention will now be described with reference to the figures of the accompanying drawings, which illustrate particular preferred embodiments of the present invention, wherein:

FIG. 1 provides a process schematic of a glycol based gas dehydration and regeneration system which can incorporate a stripping gas recycle system according to the present invention.

FIG. 2 provides a process schematic of a first embodiment of a stripping gas recycle system according to the present invention.

FIG. 3 provides a process schematic of a second embodiment of a stripping gas recycle system according to the present invention.

### DETAILED DESCRIPTION OF THE INVENTION

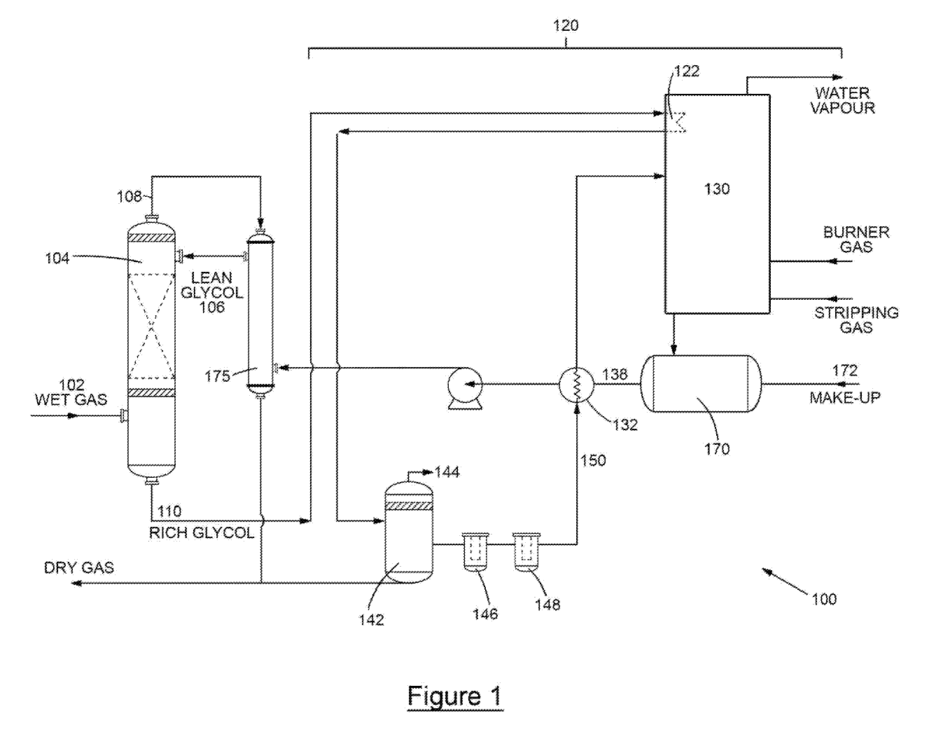

Referring firstly to FIG. 1, there is shown the basic process flow schematic for a typical glycol based gas dehydration and regeneration system 100 which can incorporate a stripping gas recycle system according to the present invention.

Any suitable glycol based water dehydrating agent can be used in this process 100. In preferred embodiments, the glycol based water dehydrating agent comprises at least one of Mono-Ethylene Glycol (MEG), Di-Ethylene Glycol (DEG) Tri-Ethylene Glycol (TEG), or Tetra-Ethylene Glycol, or mixtures thereof. For illustration purposes, the glycol based water dehydrating agent in the following description will be Tri-Ethylene Glycol (TEG).

In the process 100, a water containing gas is fed into an inlet 102 located near the bottom of a contactor tower 104 comprising a packed column including a multitude of trays and/or packing to increase the internal surface contact area of the column. The water containing gas flows upwards through the internal trays/packing. Lean glycol is fed into the contactor tower 104 at an inlet 106 near the top and cascades down through the internal trays/packing, making contact with the up-flowing gas stream. The countercurrent flow path of the glycol and the high contact surface area enhances water absorption into the glycol from the gas stream. The contactor 104 typically operates at a pressure of 10 to 150 bar and a temperature of 10 to 70° C. depending on the feed gas conditions. Dehydrated gas flows out of an outlet 108 at the top of the contactor 104, while the rich glycol flows out of an outlet 110 at the bottom of the contactor 104 and to a glycol regeneration process 120. The rich glycol contains about 90 to 98 wt % TEG.

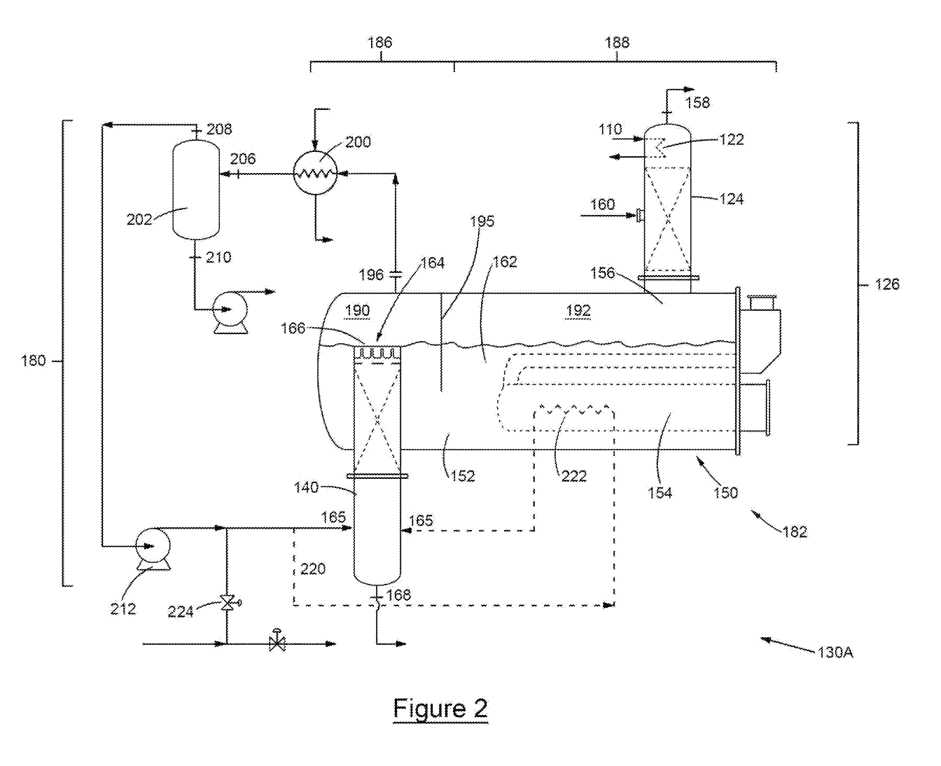

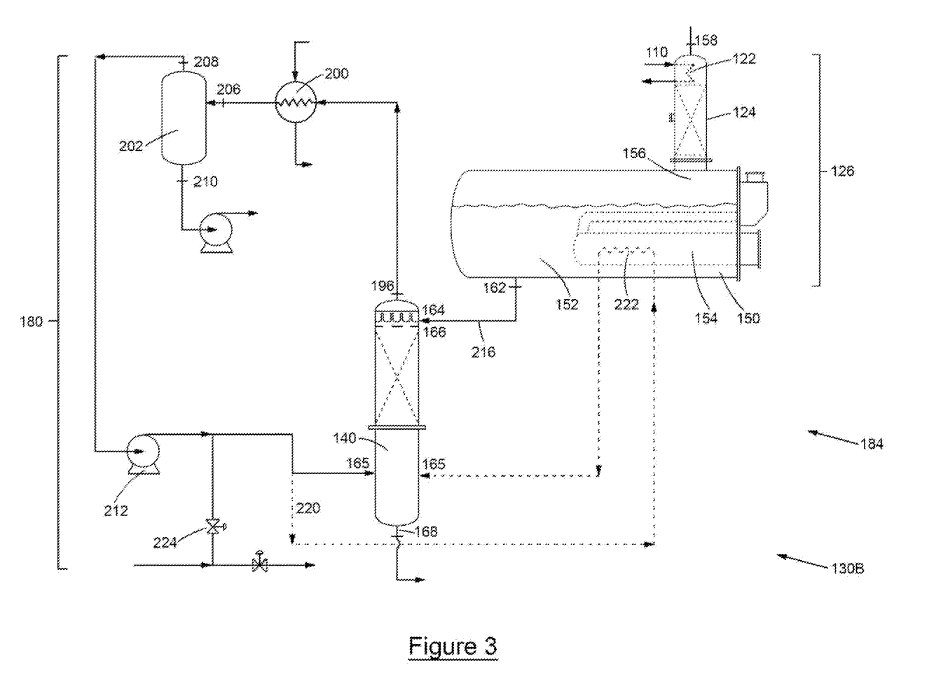

The glycol regeneration process 120 typically involves passing the rich glycol 110 through a reflux condenser 122 to partially condense the vapour leaving the column thereby minimising glycol losses. The reflux condenser 122 is typically formed as part of a still column portion 124 of a regenerator 126 of the regenerator system 130 (for example 130A (FIG. 2), or 130B (FIG. 3)) and comprises a stainless steel coil, stab-in tube, vertical U tube bundle or similar, fitted within the still column 124. In some embodiments, the pressure of the glycol will be relieved in a reduction valve (not shown) before the glycol is heated in one or more heat exchanger(s) 132.

While not illustrated, the glycol can be further heated in a cold lean/rich cross exchanger, where the glycol is heated to approximately 70° C. The cold lean/rich cross exchanger exchanges heat between an outflow 138 from a stripping column 140 from the regenerator system 130 (described below and illustrated in FIGS. 2 and 3), cooling the lean glycol to 75° C. The cold lean/rich cross exchanger typically comprises a plate, shell & tube, hair pin shell and tube or similar heat exchanger.

The preheated rich glycol then flows to a flash drum 142, designed as a vertical two phase separator with skim pipe arrangement to facilitate removal of hydrocarbon liquid. This design allows the separation of any entrained hydrocarbon vapour, and the separation of the aqueous and hydrocarbon liquid phases. The separated gas 144 may be used as stripping gas or burner gas with any excess being vented to flare (not illustrated).

The glycol is then passed through particle filters 146 to remove particulates and activated carbon filters 148 to remove any dissolved hydrocarbon and/or chemical compounds. The particulate type filter 146 is typically used to remove 99% of all suspended solids 5 micron or larger from the glycol.

The rich glycol 150 is then preheated to approximately 170° C. using a hot lean/rich cross exchanger 132. The cross exchanger 132 in turn cools lean glycol from a dried glycol outflow stream 138 from the glycol regenerator system 130 (described below) to approximately 100° C. from an operating temperature of 204° C. A plate, shell & tube, hair pin shell and tube or similar heat exchanger can be used for this service.

The rich glycol is then fed into the regenerator system 130. It should be appreciated that the particular configuration of the regenerator system 130 can vary. FIG. 1 therefore only illustrates a general process unit for the regeneration system 130. The detail of two regenerator system embodiments 130A and 130B are shown in FIGS. 2 and 3 and are described in more detail below. However, it should be appreciated that other configurations are possible, and that it is intended that the present invention covers all such variations.

Generally, most regenerator systems 130 include a regenerator 126 comprising a reboiler 150 and still column 124, and a stripping column 140. In both the embodiments illustrated in FIGS. 2 and 3, the illustrated reboiler 150 includes a fluid reservoir 152 including a heating device 154 which provides the necessary heat for glycol regeneration. In the illustrated embodiments, the heating device 154 comprises a direct gas-fired multi-return heater system which maintains a temperature of between 190 to 205° C., preferably 200° C. to 204° C., most preferably a constant 204° C. required to regenerate the TEG to 99.82 wt. %. It should be noted that TEG is degenerated at temperatures above 204° C. at normal operating pressure. The reboiler 150 is sized to ensure the fire-tubes remain submerged while maintaining a minimum ⅓ vapour space within the vessel.

The reboiler 150 is fitted with a still column 124 where the fraction having the highest boiling point, namely the glycol (for example, TEG), runs down and is collected at the bottom of the column 156, while fractions having a lower boiling point such as gas and water vapour rise upwards in the column and are removed at the top of the column 158. The temperature in the still column 124, is normally around 200° C. to 204° C., and has an operating pressure typically atmospheric to 50 kPag, but may be higher or lower depending on the design of the stripping gas recycle system. The still column 124 is packed with random packing to facilitate separation of the glycol/water vapour. The still column 124 is designed with two beds, with one stage provided above the feed nozzle 160 and one stage below. In this manner the bed acts as a two-section stripper but the packed height is minimised. The section below the feed nozzle 160 is known as the ‘heat transfer’ section and facilitates heating of the incoming glycol to the regeneration temperature. The section above the feed nozzle 160 is referred to as the ‘rectification section’ and facilitates separation of the water/glycol phase.

The partially dried glycol then flows from the bottom 162 of the regenerator 126 to an inlet 164 near the top of a stripping column 140. The partially dried glycol in the stripping column 140 is at a temperature of about 200° C. The stripping column 140 uses a dry, low pressure stripping gas 165, acquired from a stripping gas recycle process 180 (explained in detail below), to remove a further water content from the partially dried glycol. The illustrated stripping column 140 comprises one theoretical transfer stage due to the low outlet water content of the process gas, and in the attempt to limit the vapour emissions. The stripping column 140 includes a bed of random packing.

The stripping gas flows countercurrent to the glycol stream in the stripping column 140, with the dry stripping gas being fed at an inlet location 165 near the bottom of the stripping column 140, and the wet glycol being fed at an inlet location 166 near the top of the stripping column 140. The glycol is dehydrated further and flows out through an outlet 168 near the bottom of the stripping column 140 to a surge drum 170 (FIG. 1), where any required makeup glycol 172 to replace any glycol lost in the drying and regeneration process may also be fed into the process 100 from a glycol-supply (not shown). In some instances, the lean glycol exits the stripping column 140 and enters the surge drum 170 after being cooled through the above described glycol heat exchangers 132. The surge drum 170 is designed to have adequate retention time and is also sized to hold the full liquid inventory of the reboiler 150 during times of maintenance.

Any suitable stripping gas may be used. Suitable stripping gases include CO₂, N₂, or a low molecular weight hydrocarbon, such as methane or a methane containing gas, for example (burner) flue gas, flash tank gas, or fuel (product) gas from the process shown in FIG. 1. Typically, flash gas (overheads from a flash drum, for example flash drum 142) is used as this gas would otherwise be sent to flare. In some instances, some product gas may be added to the stripping gas stream where there is not enough flash gas.

It should be appreciated, that the process may include further glycol dehydration processes (not illustrated), such as a retention vessel (not shown) which implements a cold finger type process (for example see U.S. Pat. No. 4,332,643) in order to remove further water content from the glycol.

Depending on the specific conditions of the traditional glycol regeneration process 120, the TEG is dried to a maximum of ˜98.6 wt % TEG. The lean or dried glycol is fed back to the contactor through cross-exchanger 175 which exchanges heat with the dried gas outflow from the contactor 104.

In other embodiments (not illustrated), the lean glycol exits the glycol regeneration process 120 and passes through a shell & tube heat exchanger, air cooled heat exchanger or similar. This heat exchanger is designed to cool the lean TEG to within 5° C. of the outlet gas temperature.

In the process of the present invention, the stripping gas running through the stripping column 140 is recycled through a stripping gas recycle process 180, as illustrated in FIGS. 2 and 3. The exact configuration of the recycle process 180 depends on the configuration of the regenerator 126 and stripping column 140 used in the glycol regeneration system 130.

FIGS. 2 and 3 illustrate two embodiments of the stripping gas recycle process 180 having different regenerator 126 and stripping column 140 configurations. FIG. 2, illustrates the stripping gas recycle process 180 of the present invention installed on a glycol regeneration vessel 182 in which the stripping column 140 is integral with the regenerator 126. FIG. 3 illustrates the stripping gas recycle process 180 of the present invention installed in a glycol regeneration package 184 having a separate stripping column 140 and regenerator 126. It should however be appreciated that a number of other configurations interconnecting the regenerator 126 and stripping column 140 are possible, and that it is intended that the present invention could be used and covers all such variations.

Referring firstly to the glycol regeneration system 130A shown in FIG. 2, there is shown a glycol regeneration vessel 182 comprising a horizontally orientated vessel including a fluid reservoir 152. At one end of the vessel 182 is located a regenerator 126 (comprising the still column 124 and the reboiler 150) and at the other end of the vessel 182 is located a stripping column 140. The vessel 182 is therefore essentially split into a stripper portion 186 and a regenerator portion 188. The fluid reservoir 152 of the reboiler 150 of the regenerator 126 is essentially shared between the stripping column 140 and still column 124. The fluid reservoir 152 fluidly links a lower glycol fluid outlet 162 of the regenerator 126 and an upper glycol fluid inlet 164 of the stripping column 140. The stripping column 140 acts as an over-weir controlling the lean glycol level in the fluid reservoir 152. The glycol level in the fluid reservoir 152 (reboiler) of glycol regeneration vessel 184 of the glycol regeneration system 130B is maintained by an internal stand pipe/inlet (not illustrated) to the stripping column 140 located at the discharge or opposite end to the reboiler 150. As described above, the regenerator 126 functions to separate water content from the water containing glycol to substantially produce water vapour as a top fraction and a partially dried glycol as a bottom fraction. The stripping gas strips further water content from the glycol to produce a dried glycol and a wet stripping gas.

The fluid reservoir/reboiler includes a heating device 154, in the illustrated case, a gas fired heating coil. However, it should be appreciated that any suitable heating element could be used, for example oil heated, electrical coils or the like. The heating device 154 heats the partially dried glycol in the fluid reservoir 152 to between 180 to 210° C., preferably between 190 to 205° C., more preferably to around 200° C. to 204° C., most preferably to about 204° C.

It is preferred that the gas/vapour content 190 of the stripping column 140 is substantially fluidly separated from the gas/vapour content 192 of the regenerator 126. This separation ensures that the stripping gas to substantially flow through the stripping column 140 and the stripping gas recycle process 180 and not bypass through the regenerator 126. The vessel 182 therefore includes a fluid barrier 195 between the regenerator portion 188 and the stripper portion 186, substantially fluidly separating the gas/vapour content 190 of the stripper portion 186 from the gas/vapour content 192 of the regenerator portion 188. The illustrated fluid barrier 195 comprises a baffle or weir. The fluid barrier 195 includes at least one fluid communication element, in this case a plurality of apertures (not illustrated) to equalise any pressure difference that may arise between the gas/vapour content 190 of the stripper portion 186 and the gas/vapour content 192 of the regenerator portion 188. It should be appreciated that a small amount of stripping gas will leak from the system 130A via still outlet 158 during operation as the fluid barrier/baffle 195 needs weep apertures to maintain pressure equilibrium.

The illustrated stripping gas recycling system 130A comprises a substantially closed gas recycle system that circulates through the stripping column 140. The stripping gas recycling system 130A (and 130B) therefore has minimal gas emissions once a working amount of stripping gas is fed into the stripping column 140 for recycle. However, it should be appreciated that some stripping gas may escape the system 130A (or 130B) due to pressure and other process requirements requiring make up stripping gas may also need to be fed into the system 130A (or 130B). The stripping gas make up is preferably flash gas but could be N₂ or another external gas source.

Following the stripping gas recycle system 130A from the stripping gas outlet 196 of the stripping column 140, the wet stripping gas is firstly fed to a cooling vessel 200, typically an air cooler, plate and frame, shell and tube or similar heat exchanger in which the water and glycol vapour is condensed and separated from the wet stripping gas. The wet stripping gas is at a temperature of at least 150° C., typically 200° C. when entering the stripping gas separation process 180. The cooling vessel 200 cools the vapour to less than 100° C., typically about 50° C.

The stripping gas is then fed into a gas-liquid separator 202, in which a water content is separated from the cooled wet stripping gas 206. It should be appreciated that any glycol content entrained or otherwise contained in the wet stripping gas would also be separated from the stripping gas during the stripping gas separation process 180. Any suitable separator 202 such as a knockout drum, blowdown tank or a flash tank can be used. The separator 202 may have simple internals, i.e. only a mist mat, or may have more complex coalescing internal elements. The separator 202 produces a stripping gas fraction 208 and a liquid water/glycol fraction 210.

The water containing fraction 210 separated from the stripping gas separation process 180 is returned to any point in the glycol regeneration process, preferably to the flash tank 142 (FIG. 1). The glycol can therefore be recycled back into that glycol regeneration process 120.

The drier stripping gas 208 is then fed to a blower 212 to increase the gas pressure of the drier stripping gas fraction before being injected into the bottom of the stripping column 140. The pressure increase across the blower 212 is typically only ˜20 kPa to account for pressure losses in the circulation of the vapour, but may be higher or lower depending on the design of the stripping gas recycle system.

As indicated by the dash process lines, from the blower 212, the pressurised stripping gas 220 may be heated to 80 to 150° C., preferably to around 150° C., through heating coils 222 located proximate or in the heating device 154 in the fluid reservoir 152 of the regeneration vessel 182.

Whether heated or not, the drier stripping gas 165 is fed into the stripping column 140 for reuse to dehydrate partially dried glycol flowing in the stripping column 140.

The illustrated stripping gas recycle system 180 also includes a gas feed inlet 224 located between the blower 212 and the stripping column 140. However, it should be appreciated that this gas inlet 224 could be located at any suitable point in the stripping gas recycle system 180, for example located prior to the blower 212 or another position, suited to the pressure of the fed gas. The gas inlet 224 enables a stripping gas content to be fed as either make up gas, or an amount of gas can be fed during start up. In this respect, it should be appreciated that the recycle system 180 must be initially charged with a desired amount of stripping gas, to enable that gas to circulate through the recycle system 180. In some instances, where the stripping gas is sourced from a co-located process step, for example the flash vessel 142 (FIG. 1), the stripping gas from that flash vessel 142 must be accumulated over time in order to obtain the desired amount of stripping gas for the recycle system 180. In other instances, the recycle system 180 can be charged with a suitable stripping gas from an external source.

FIG. 3 illustrates a second embodiment of the stripping gas recycle process 180 of the present invention installed in a glycol regeneration package 130B having a separate stripping column 140 and regenerator 126.

In this embodiment, the regenerator 126 comprises an integrated still column 124 and reboiler 150 attached to the base of the still column 124. The reboiler 150 heats the partially dried glycol to a temperature of around 180 to 210° C., preferably around 200 to 204° C. The glycol inlet 164 of the stripping column 140 is fluidly connected to the glycol outlet 162 of the regenerator 126 via a conduit or pipe 216. In this embodiment, the separate stripping column 140 and regenerator 126 ensure that the gas/vapour content of the stripping column 140 is substantially fluidly separated from the gas/vapour content of the regenerator 126. No fluid barrier is therefore needed in the reboiler 150.

The stripping gas recycle system 180 is therefore fluidly connected to the stripping gas inlet and outlet of the stripping column. It should be appreciated that the stripping gas recycle system 180 is essentially the same as described in relation to the stripping gas recycle system 180 illustrated in FIG. 2. Accordingly, the same reference numerals have been used, and it should be understood that the preceding process description also equally applies for this stripping gas recycle system 180.

Again, as indicated by the dash process lines, from the blower 212, the pressurised stripping gas may be heated to 80 to 150° C., preferably around 150° C. through heating coils 222 located proximate or in the heating device 154 in the fluid reservoir 152 of the heater portion of the reboiler 150.

It should be appreciated that the stripping gas recycle process 180 can be integrated as part of newly fabricated stripping column and/or glycol regeneration processes. Equally, the stripping recycle process 180 could be retrofitted into an existing stripping column and/or glycol regeneration processes. In this respect, the stripping gas recycle system 180 illustrated in FIGS. 2 and 3 may be retrofitted to existing installed glycol regeneration processes. Where the system is retrofitted, the illustrated stripping gas recycle system 180 can be connected between the stripping gas inlet 165 and stripping gas outlet 196 of an existing stripping column 140. Where the stripping column 140 and regenerator 126 are separate, as shown in FIG. 3, no further components need to be installed into the stripping column 140 or regenerator 126. However, where the stripping column 140 is integrated into a single vessel 182 with a regenerator 126 and connected by a common fluid reservoir 152, as shown in FIG. 2, a fluid barrier 195, such as a plate, or a weir, must also be installed in the fluid reservoir 152 between the regenerator portion 188 and the stripper portion 186. The fluid barrier 195 is positioned in the fluidly connected vessel 182 to substantially fluidly separate the gas/vapour content 190 of the stripper portion 186 from the gas/vapour content 192 of the regenerator portion 188. Again, the fluid barrier 195 should include at least one fluid communication element, such as one or more apertures or openings (not illustrated) between the gas/vapour content 190 of the stripper portion 186 and the gas/vapour content 192 of the regenerator portion 188.

The stripping gas recycle process and system of the present invention results in very little stripping gas being vented from the still overheads and low ongoing requirements once the system is operational. If methane, typically flash gas or fuel/sales gas, is used as the stripping gas then this invention significantly reduces the carbon emissions. If fuel/sales gas is used as the stripping gas then the reduced requirements have the additional economic benefits of more gas being available to sell.

Furthermore, the stripping gas recycle process and system of the present invention provides a reduction in carbon emissions as compared to existing glycol regeneration systems, and therefore reduces the current (where retrofitted) or potential (where newly constructed) carbon tax or similar emission payments for those emissions when used in a glycol regeneration system, in those countries with a carbon tax or emission tax/payment regime.

Where an alternative gas is currently being used, for example N₂, for stripping, use of the present invention provides an operating cost saving, with a reduction of the quantity of stripping gas required.

Moreover, the low volume of stripping gas required for the stripping gas recycle process and system of the present invention will often result in the normal flash gas stream being adequate for use in the stripping units, so that there is little to no need to use sales gas (which reduces profit) or produce other gases, such as N₂ (ongoing operating cost and initial capital cost) as a stripping gas.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

We claim:

1. A stripping gas recycle process for a stripper which removes a water content from a water containing glycol dehydration agent using a stripping gas to produce a dried glycol and a wet stripping gas, the recycle system comprising:
at least one stripping gas separation process, the stripping gas separation process being fed wet stripping gas from a stripper and separating the water content from the wet stripping gas, to produce a water containing fraction and a drier stripping gas fraction, the drier stripping gas fraction being fed into the stripper.

2. The stripping gas recycle process according to claim 1, wherein the stripping gas separation process comprises at least one of:
a cooling process, in which the water content is condensed and separated from the stripping gas;
a gas-liquid separator, in which the water content is separated from the stripping gas; or
a stripping process, in which the wet stripping gas is contacted with a secondary stripping fluid to separate the water content from the stripping gas.

3. The stripping gas recycle process according to claim 2, wherein the cooling process cools the wet stripping gas to 0 to 99° C. for condensation of the water content of the wet stripping gas.

4. The stripping gas recycle process according to claim 1, wherein the stripping gas separation process includes at least one cooling process, to cool the gas to 0 to 99° C., followed by a further separator.

5. The stripping gas recycle process according to claim 4, wherein the further separator comprises a knock-out drum or flash type separator.

6. The stripping gas recycle process according to claim 1, further including a pressure enhancing device, to increase the pressure of the drier stripping gas fraction before being fed into the stripper.

7. The stripping gas recycle process according to claim 1, further including a heating process in which the drier stripping gas is heated prior to being fed into the stripper.

8. The stripping gas recycle process according to claim 1, wherein the stripping gas is heated to 50 to 200° C.

9. The stripping gas recycle process according to claim 1, further including a gas inlet through which at least one of the following can be fed into the gas recycle system:
a stripping gas content during start up; or
a make-up content of the stripping gas.

10. The stripping gas recycle process according to claim 1, wherein the stripping gas comprises a component removed from a process step of an adjoining gas regeneration process comprising a process for regeneration of a water containing glycol that has been used as a dehydration agent to remove water from a fluid.

11. The stripping gas recycle process according to claim 1, wherein the stripping gas comprises at least one of CO₂, N₂, flue gas, or a low molecular weight hydrocarbon having the formula CₙHₙ₊₂, wherein n is an integer in the range of 1 to 4.

12. A stripping process for regeneration of a water containing glycol dehydration agent, the stripping process comprising:
a stripper which is fed a water containing glycol and a stripping gas, the stripping gas removing a water content from the water containing glycol to produce a dried glycol and a wet stripping gas; and
a stripping gas recycle process according to claim 1.

13. A process for regeneration of water containing glycol dehydration agent that has been used to remove water from a fluid, the process including:
a regenerator into which the water containing glycol is fed, the regenerator separating a water content from the water containing glycol to substantially produce water vapour as a top fraction and a partially dried glycol as a bottom fraction;
a stripper which is fed the partially dried glycol from the regenerator and a stripping gas, the stripping gas removing further water content from the glycol to produce a dried glycol and a wet stripping gas; and
a stripping gas recycle process according to claim 1.

14. The process according to claim 13, wherein the gas/vapour content of the stripper is substantially fluidly separated from the gas/vapour content of the regenerator.

15. The process according to claim 13, further comprising a heater fluidly linked between the stripper and the regenerator, the heater heating the partially dried glycol and wherein the stripper, heater and regenerator are integrated within a fluidly connected vessel.

16. The process according to claim 15, wherein the stripper is located in a stripper portion of the fluidly connected vessel and the regenerator is located in regenerator portion of the fluidly connected vessel, the regenerator portion being spaced apart from the stripper portion, the fluidly connected vessel further including a fluid barrier between the regenerator portion and the stripper portion, substantially fluidly separating the gas/vapour content of the stripper portion from the gas/vapour content of the regenerator portion.

17. The process according to claim 15, wherein the fluid barrier comprises a plate, preferably a baffle or a weir.

18. The process according to claim 15, wherein the fluid barrier includes at least one fluid communication element, preferably at least one aperture, between the gas/vapour content of the stripper portion and the gas/vapour content of the regenerator portion.

19. The process according to claim 16, wherein the fluid barrier is located in the heater between the regenerator portion and the stripper portion.

20. The process according to claim 1, wherein the glycol dehydration agent comprises at least one of Mono-Ethylene Glycol, Di-Ethylene Glycol Tri-Ethylene Glycol, Tetra-Ethylene Glycol or a mixture thereof.
